(19) United States
(12) Patent Application Publication
(10) Pub. No.: US 2014/0289162 A1
(43) Pub. Date: Sep. 25, 2014

(54) SYSTEM FOR MANAGING MOVES

(71) Applicant: Unpakt, LLC, New York, NY (US)

(72) Inventors: Sharone Ben-Harosh, New York, NY (US); Daniel Cooke, Staten Island, NY (US); Amish Gandhi, New York, NY (US); John Negron, New York, NY (US); Israel Carmel, Jericho, NY (US)

(21) Appl. No.: 14/299,318

(22) Filed: Jun. 9, 2014

Related U.S. Application Data
(62) Division of application No. 13/741,821, filed on Jan. 15, 2013.
(60) Provisional application No. 61/698,089, filed on Sep. 7, 2012.

(51) Int. Cl. G06Q 30/02

(52) U.S. Cl. CPC G06Q 30/0282
USPC 705/347

(57) ABSTRACT

Some embodiments of the invention may reduce the amount of time a consumer spends coordinating a move. A system is provided which may guide the consumer through the process of planning the move, including developing an inventory of items to be transported. Based on the consumer's plan, quotes for the move may be provided from multiple movers, and each quote may be an exact price that a mover will charge, rather than merely an estimate. To enable movers to provide exact quotes, some embodiments of the invention implement a standard pricing methodology. The system may allow movers to define pricing information in accordance with the methodology, and this information may be used to calculate a quote for a move when a consumer requests one.

### RELATED APPLICATIONS

This application is a divisional of U.S. patent application Ser. No. 13/741,821, filed Jan. 15, 2013, entitled SYSTEM FOR MANAGING MOVES, bearing Attorney Docket No. U1192.70000US03, which claims priority under 35 U.S.C. §119(e) to U.S. Provisional Patent Application Ser. No. 61/698,089, filed Sep. 7, 2012, entitled MOVE MANAGEMENT SYSTEM. The entirety of each of the foregoing documents is incorporated herein by reference.

### BACKGROUND OF INVENTION

Scheduling a mover (i.e., an entity, such as a moving company, which transports items belonging to a person or business from one location to another) to perform a move (i.e., a project which includes, but is not necessarily limited to, the transportation of items (e.g., furniture, appliances, belongings, etc.) from one or more origin locations to one or more destination locations, such as from a residence or business at one location to a residence or business at another location) is a time-consuming process. For example, to coordinate a residential move, a consumer typically calls between two to five movers, and either spends about thirty minutes on the phone with each to describe what is to be moved, or requests that each mover visit the residence to provide an in-home estimate, requiring that the consumer set aside time (often during work hours) to meet the mover at the residence. The process of gathering estimates typically takes several hours, on average.

Movers often quote a price for a move using an hourly model. That is, a mover typically estimates how long a move will take based on a consumer's description of what is to be moved, including how many men and what type of equipment will be needed. This quote is an inexact estimate. For example, based on a consumer's description of items in a residence, a mover may estimate that the job will take three men and a moving truck, at $125 per hour, for 4 hours. However, the actual move may take longer, perhaps because the consumer's description of the items to be moved proves to be inaccurate, because necessary equipment in the consumer's residence (e.g., an elevator) is unavailable, or because the mover deliberately quoted a lower price to get hired. As a result, a move that was supposed to cost the consumer $500 could easily cost twice that, or more.

When a consumer chooses a mover to perform a move, he/she often cannot be certain that he/she has made the best choice, as verifying that a mover has a good reputation can be difficult. In addition, many consumers move very infrequently, perhaps four to five times over their lifetime, while movers perform moves every day, and as a result are adept at explaining why a move cost much more than originally estimated, why the mover should not be responsible for items broken during the move, etc. As a result, consumers and movers are often not on equal footing when move-related issues arise.

### BRIEF SUMMARY OF INVENTION

Some embodiments of the invention provide a system which may significantly reduce the amount of time a consumer, business or other entity (hereinafter referred to as a “consumer,” for simplicity, although it is to be understood that this term refers to any party which may arrange for a move to occur) spends coordinating a move. In some embodiments of the invention, the system may guide the consumer through the process of planning the move in detail, including developing an inventory of items to be transported during the move, and requesting various move-related services. Based on the consumer's plan, the system may provide quotes for the move from multiple movers, and each quote may be an exact price that a mover will charge, rather than merely an estimate. As such, when the consumer selects a particular mover to perform the move, he/she may have assurance that the quoted price is the price that he/she will ultimately pay for the move.

To enable movers to provide exact quotes for a move, embodiments of the invention may employ a standard methodology for pricing moves, which movers may follow in exchange for the opportunity to market their services to consumers through the system. Although any suitable pricing methodology may be used, in some embodiments of the invention which are described in detail below, moves are priced based at least in part on the volume of the items that are to be transported, and any move-related services which the consumer requests. The system may allow movers to define per-volume and per-service pricing information, and this information may be used to calculate a price for a move when a consumer requests a quote.

Some embodiments of the invention may provide an interface between consumers and movers, ensuring that only reputable movers are allowed to submit a quote for a move, and supplying third-party objectivity when move-related issues arise. As a result, a consumer may have greater confidence in their choice of a mover for a particular move.

The foregoing is a non-limiting summary of the invention, some embodiments of which are defined by the attached claims.

### BRIEF DESCRIPTION OF DRAWINGS

The accompanying drawings are not intended to be drawn to scale. In the drawings, each identical or nearly identical component as illustrated in various figures is represented by a like numeral. For purposes of clarity, not every component may be labeled in every drawing. In the drawings:

FIG. 1 is a flow chart depicting a representative process for gathering pricing information from movers, in accordance with some embodiments of the invention;

FIGS. 2A-2B depict representative screen interfaces which may be employed by a mover to supply pricing information, in accordance with some embodiments of the invention;

FIG. 3 depicts a representative screen interface which may be employed by a user to supply information relating to interstate moves, in accordance with some embodiments of the invention;

FIG. 4 depicts a representative screen interface which may be employed by a mover to define daily availability, in accordance with some embodiments of the invention;

FIG. 5 is a flow chart depicting a representative process for assisting a consumer in developing a plan for, and receiving a price for, a move, in accordance with some embodiments of the invention;

FIG. 6 depicts a representative screen interface enabling a consumer to begin the development of a detailed move plan, in accordance with some embodiments of the invention;

FIGS. 7A-7B depict representative screen interfaces enabling a consumer to define items to be transported during a move, in accordance with some embodiments of the invention;

FIG. 8 depicts a representative screen interface enabling a user to describe a particular item to be transported during a move, in accordance with some embodiments of the invention;

FIG. 9 depicts a representative screen interface providing an inventory of items to be transported during the move, in accordance with some embodiments of the invention;

FIG. 10 depicts a representative screen interface enabling a consumer to specify over-sized items to be transported during a move, in accordance with some embodiments of the invention;

FIGS. 11A-11B depict example screen interfaces enabling a consumer to request services to be provided during a move, in accordance with some embodiments of the invention;

FIG. 12 is a sequence diagram depicting a representative technique for identifying candidate movers for a particular move, in accordance with some embodiments of the invention;

FIG. 13 depicts a representative screen interface displaying quotes for a move from multiple movers, in accordance with some embodiments of the invention;

FIG. 14 depicts a representative screen interface enabling a consumer to secure a binding quote for a move, in accordance with some embodiments of the invention;

FIGS. 15A-15B depict example administration screen interfaces, in accordance with some embodiments of the invention; and

FIG. 16 is a block diagram depicting a representative of a computer system with which various aspects of embodiments of the invention may be implemented.

### DETAILED DESCRIPTION OF INVENTION

In some embodiments of the invention, a system is provided which may significantly reduce the amount of time a consumer spends arranging for a mover to perform a move. The system may, for example, guide the consumer through the creation of a detailed plan for the move, including an inventory of items to be transported and any identification of any services to be requested. The plan may provide a basis for quotes for the move from multiple movers. Each quote may, for example, be an exact price that the mover would charge the consumer for the move, rather than an estimate of charges, providing the consumer assurance that the quoted price is the price that he/she will pay if he/she makes no changes to the plan.

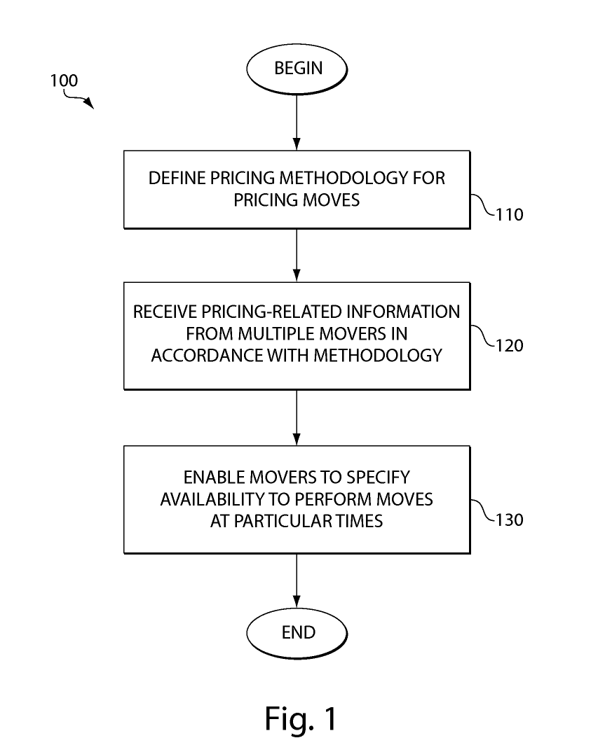

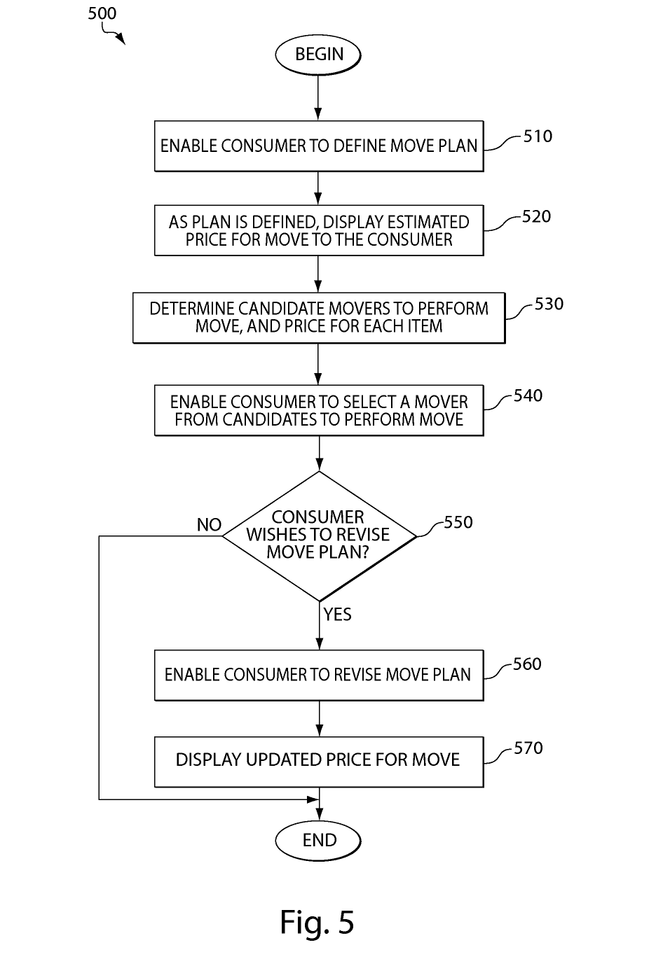

In addition to guiding consumers through the creation of a plan for a move, some embodiments of the invention enable movers to supply information which is used to calculate a price for the move when the consumer requests a quote. In this respect, some embodiments of the invention implement a standard pricing methodology, whereby moves are priced based at least in part on the volume of items to be transported during the move and any requested move-related services. In the description that follows, FIGS. 1-4 relate generally to representative processes through which movers may supply information relating to pricing and availability, and FIGS. 5-14 relate generally to representative processes through which a consumer may define and/or alter a detailed move plan, and select a mover for a move from among qualified movers.

FIG. 1 depicts an representative overall process 100 for receiving information from movers. At the start of representative process 100, in act 110, a pricing methodology is defined whereby movers will price moves. Any suitable methodology may be defined and employed, as embodiments of the invention are not limited in this respect.

Conventionally, a mover uses one of three standard pricing models, which are governed federally and by individual states, to price a move. The three models allow a mover to price a move by (1) weight and distance, (2) hourly, or (3) via a binding quote, which may be determined in any suitable manner. Binding quotes, which compel a mover to transport a consumer's items from one location to another for a set price, are rare, because there is no generally accepted methodology for arriving at an exact price for a move, and because changes to a move plan initially defined by the consumer are common. In accordance with some embodiments of the invention, however, a pricing methodology is set forth whereby a move is priced based at least in part on the volume of items to be transported, and/or any ancillary services (described below) to be provided by the mover during a move. In some embodiments of the invention, in exchange for the opportunity to market their services to consumers, movers agree to define how their services are priced on a per-volume and per-service basis.

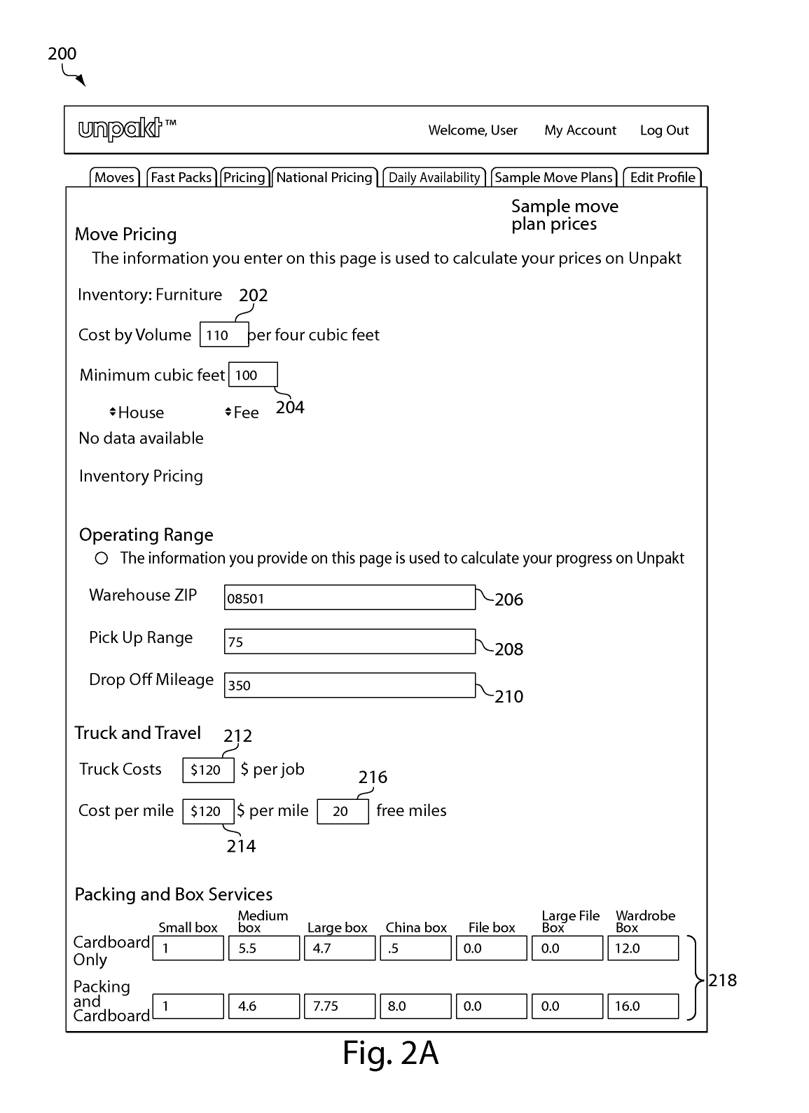

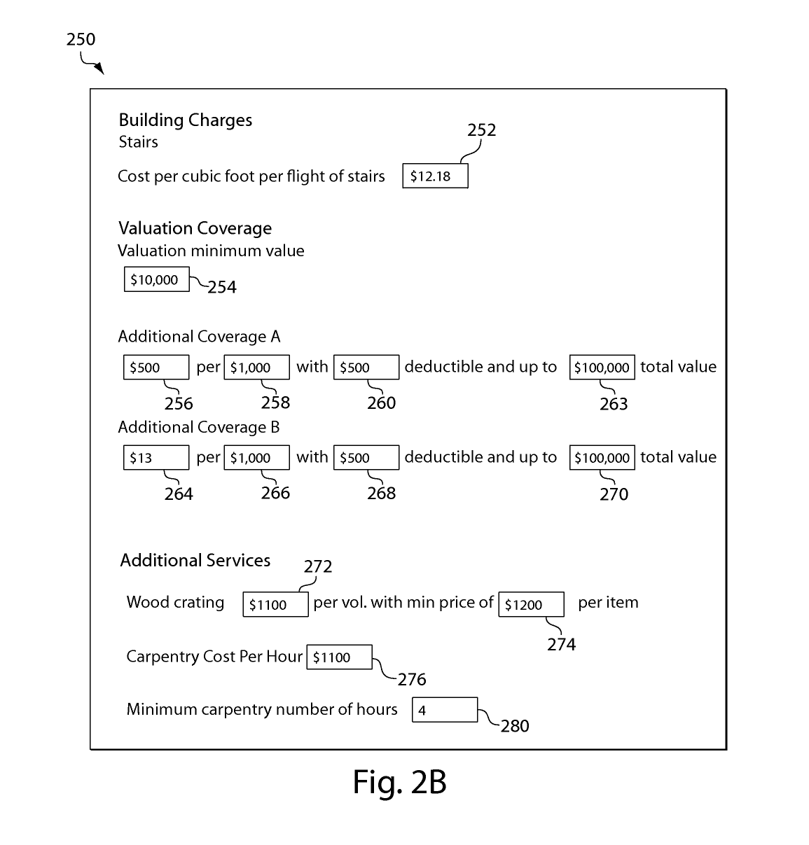

Representative process 100 then proceeds to act 120, wherein pricing-related information is received from multiple movers, in accordance with the defined methodology. FIGS. 2A-2B depict representative screen interfaces 200 and 250 which enable a mover to supply pricing-related information according to a per-volume and per-service methodology.

Representative screen interfaces 200 and 250 (and other representative screen interfaces described below) may take the form of screen interfaces presented via a web browser, as is well-known in the art. It should be appreciated, however, that embodiments of the invention are not limited to being implemented via web- or Internet-related technologies. Any suitable tools and/or techniques may be used to collect and/or display information to a user, whether the user is a mover, consumer, or other party. For example, a stand-alone application executing on a computer at a mover's location may present screen interfaces which enable the mover to supply pricing-related (and/or other) information. Any suitable mode of implementation may be used, as embodiments of the invention are not limited in this respect.

Representative screen interface 200 includes input facility 202, which allows a mover to define a volume-based price (in the example shown, the price is per cubic foot) for items to be transported, and input facility 204, which allows the mover to specify a minimum volume which it will transport. Input facility 206 enables a mover to specify a location from which any moving trucks needed for the move will originate, input facility 208 enables a mover to specify a maximum distance from this location at which items to be moved will be picked up, and input facility 210 enables a mover to specify a maximum distance from the pickup location to which items to be moved will be transported. Input facility 212 enables a mover to specify a flat fee for use of the truck, input facility 214 enables a mover to specify a price per mile for the truck's travel, and input facility 216 enables a mover to specify a number of “free” (i.e., uncharged) miles which the truck would travel before the price per mile is charged. Input facility 218 enables a mover to specify prices for different sized boxes supplied to the consumer for their use, and prices for packing items in different sized boxes.

Representative interface 250 includes input facility 252, which allows a mover to specify a per-volume price for transporting items up or down a specified number of flights of stairs. Input facilities 254-270 enable a mover to specify insurance coverage for items transported during a move. Specifically, input facility 254 enables a mover to specify a minimum value of items for insurance coverage to become active, input facilities 256-262 enable a mover to specify additional coverage under a first policy (in the example shown, $5 of coverage per $1,000 of items transported with a $500 deductible with up to a $100,000 total value), and input facilities 264-270 enable a mover to specify additional coverage under a second policy (in the example shown, $13 of coverage per $1,000 of items, with a $500 deductible and up to a $100,000 total value).

Input facilities 272-280 enable a mover to specify pricing information relating to various services. Specifically, input facility 272 enables a mover to specify a per-volume price for constructing wood crating for an item, and input facility 274 enables a minimum price per item to be specified. Input facility 276 enables a mover to specify an hourly rate for carpentry (e.g., to disassemble and/or assemble items of furniture, etc.), and input facility 280 enables a minimum number of carpentry hours to be specified.

It should be appreciated that although the representative input facilities described above provide for a mover to supply input in the form of text, embodiments of the invention are not limited in this respect, and may provide for mover input in any suitable form. It should also be appreciated that embodiments of the invention are not limited to collecting the specific items of pricing-related information described above. Any suitable information may be collected. Example items of information which are not described above but which may be collected include information relating to storage services, and to a mover making extra stops during a move (e.g., allowing a customer to drop off items before reaching a final move destination, pick items up from a second stop prior to transporting them to the final move destination, etc.). Numerous other items of information may be collected.

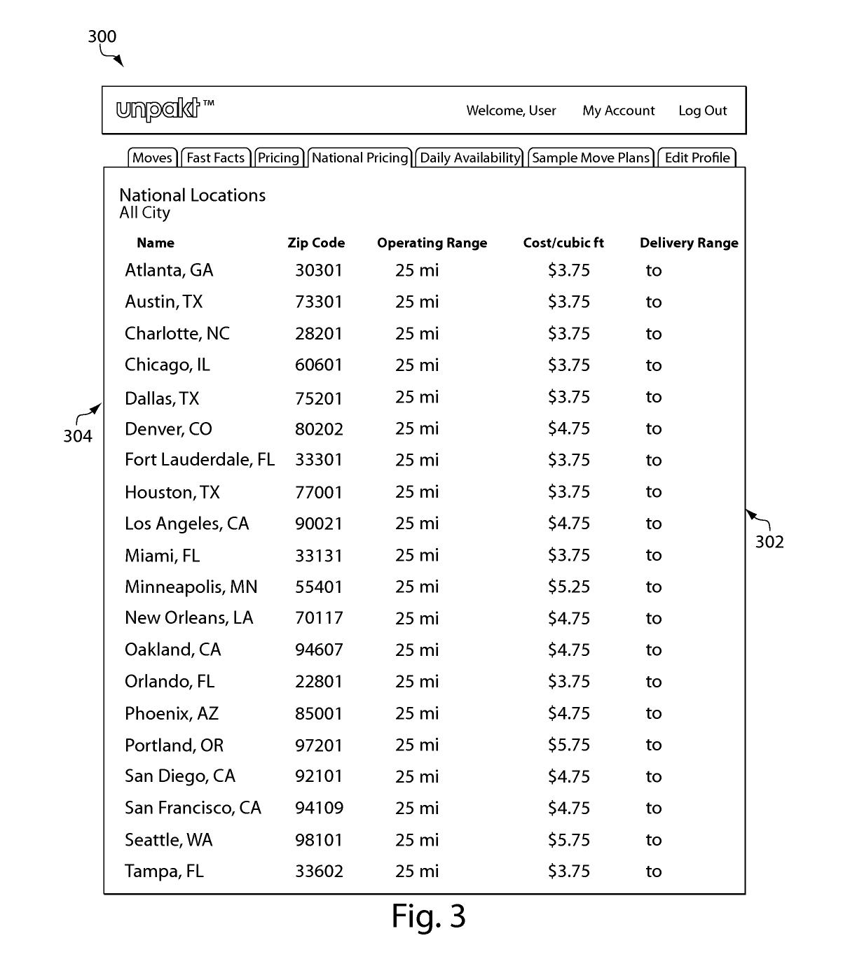

FIG. 3 depicts a representative screen interface 300 through which a mover may supply information relating to interstate moves. Representative screen interface 300 includes table 302, which enables a mover to specify per-volume prices to transport items from the location specified via input facility 206 (FIG. 2A) to specified locations. Thus, in the example shown, row 304 indicates that a mover charges $3.75 per cubic foot to transport items from a specified location to Atlanta, Ga. Although table 302 includes a representative set of possible destinations for a move, any destination may be specified, as embodiments of the invention are not limited in this respect.

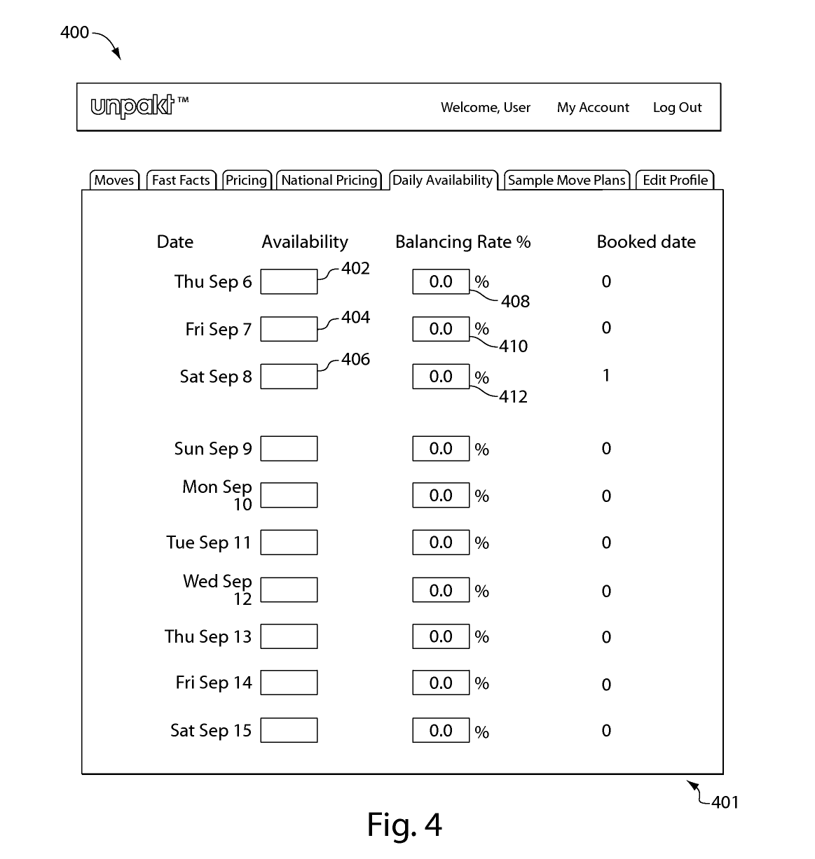

At the completion of act 120 (FIG. 1), representative process 100 proceeds to act 130, wherein movers are allowed to specify their availability to perform moves at particular times. FIG. 4 depicts representative screen interface 400 which provides an example facility for receiving availability information. Specifically, table 401 enables a mover to specify availability on a day-by-day basis, as well as a percentage premium that may be charged for performing a move on certain days on which demand for its services are high (i.e., a “balancing rate”). Thus, in table 401, input facilities 402 and 408 enable a mover to specify its availability (e.g., capacity) and balancing rate for Thursday, September 6, input facilities 404 and 410 its availability and balancing rate for Friday, September 7, and input facilities 406 and 412 its availability and balancing rate for Saturday, September 8. Other input facilities (not labeled) are provided for other days.

Representative screen interface 400 may enable a mover to specify its availability in any suitable fashion. In one example, a mover may specify a quantity of workers available for moves on a given day. However, other ways of quantifying availability may alternatively be used, such as a number of trucks available, a number of available man-hours, number of man-days, etc.

As described in greater detail below, in some embodiments, when a mover is “booked” by a consumer for a move on a particular day, the mover's availability may be automatically adjusted, so that if the mover's capacity for other (i.e., subsequently booked) moves is exhausted, its pricing-related information is no longer used to calculate quotes for those moves. For example, if a mover specifies a capacity of three moves for a particular day, and then is booked for three moves that day, that mover may be deemed unavailable for moves subsequently booked by other consumers, and those consumers may not be shown a quote from that mover.

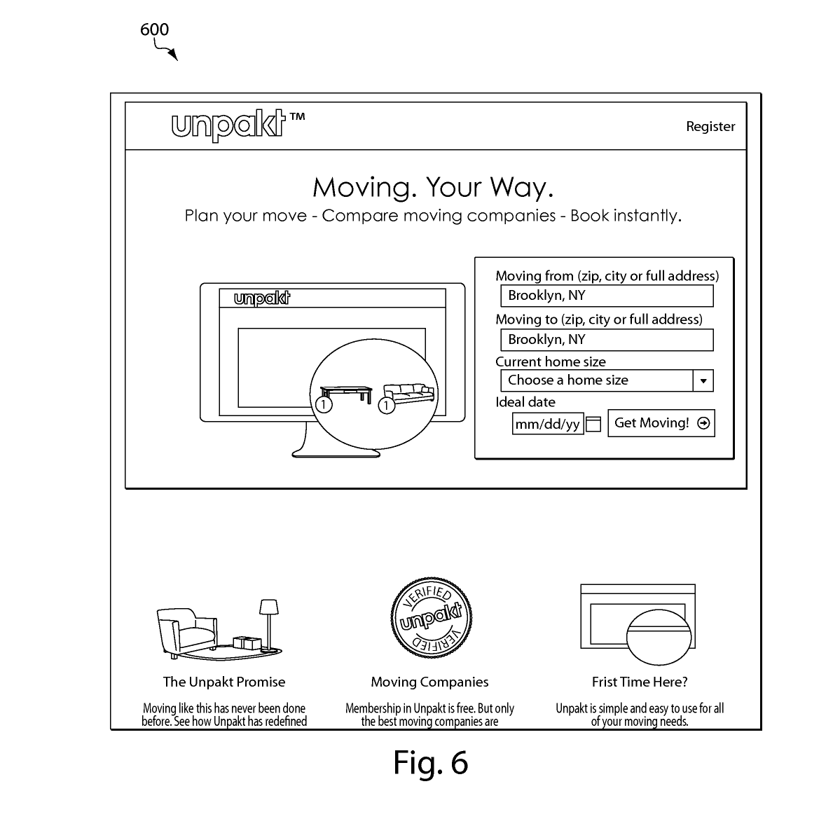

FIG. 5 depicts a representative process 500 whereby a consumer may develop a detailed plan for, and receive a quote for, a particular move. At the start of representative process 500, a consumer is allowed to define a detailed move plan in act 510. FIG. 6 depicts representative screen interface 600, which provides a consumer with an overall basic understanding of the process of arranging a move, including the development of a move plan.

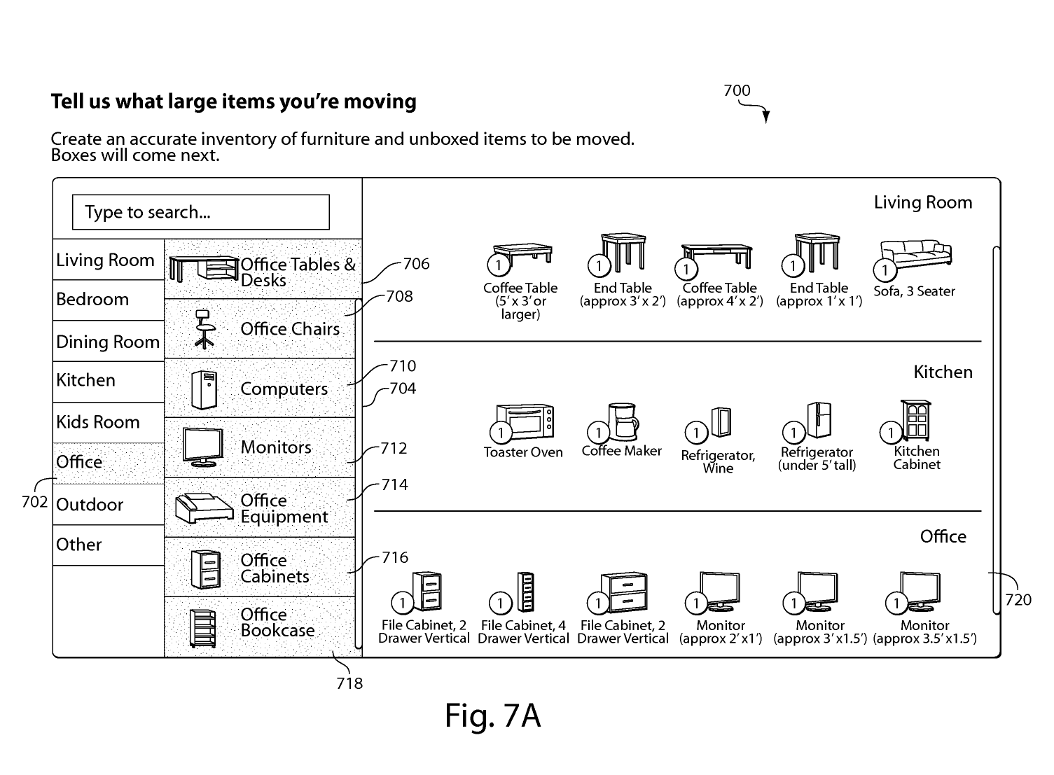

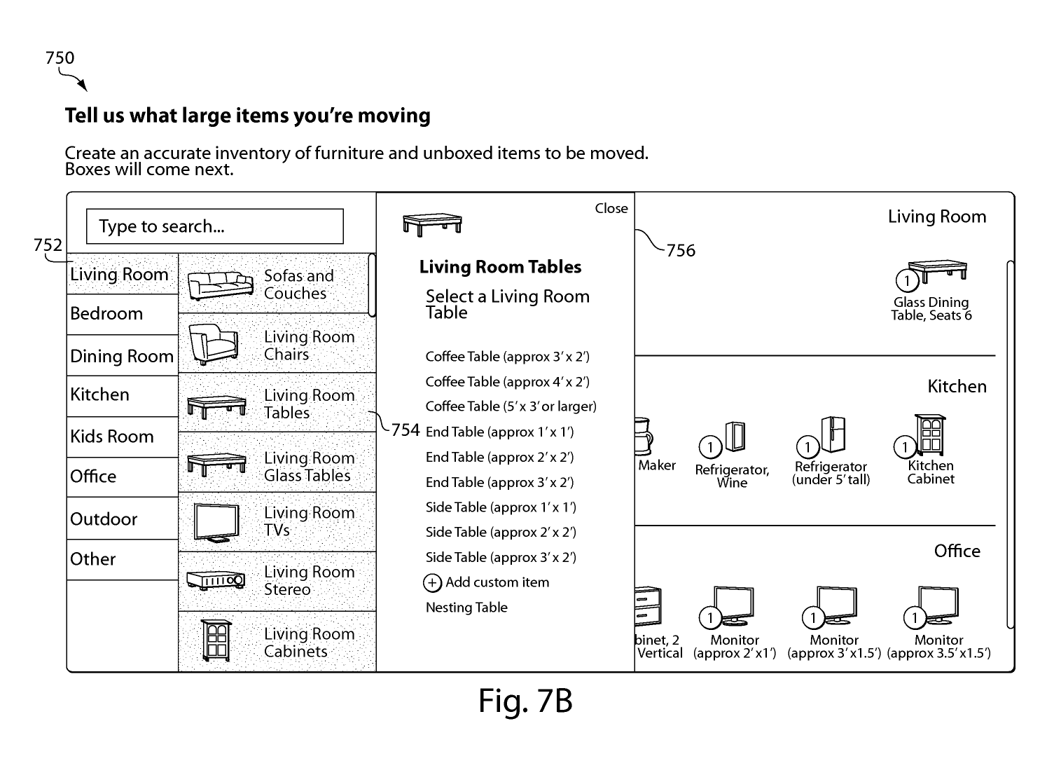

In some embodiments of the invention, developing a move plan includes specifying an inventory of items to be moved. FIGS. 7A-7B depict representative screen interfaces 700 and 750, which may be used to guide a consumer through the process of creating an inventory by allowing the consumer to select from among sample items which are typically found in various rooms of a residence. In representative screen interface 700, a consumer has provided input via facility 702 (e.g., by clicking on or rolling over the word “Office”), thereby causing menu 704, which includes items typically found in an office, to appear. The consumer may then select from the menu (in the example shown, by providing input via any of facilities 706-718) to indicate that a particular piece of office furniture should be added to the inventory. For example, a consumer may specify that an office chair is to be added to an inventory by providing input via (e.g., clicking) facility 708. Doing so may cause the office chair to be added to the portion of the overall inventory which is graphically depicted in “Office” area 720. Other menus (and/or other display methods) may be used to display items typically found in other rooms in a residence, and a consumer may add any of those items to an inventory by providing input in any suitable manner.

For some items, more information may be collected. In this respect, representative screen interface 750 depicts an additional menu 756 which may be presented when the consumer indicates that a “living room table” is to be added to an inventory by providing input via facility 754. The consumer may select an approximate size for the table from among the entries in menu 756, enabling the volume of the table to be calculated. A consumer may specify a size for any one or more other items via similar input facilities (e.g., other menus displayed when other items are selected for inclusion).

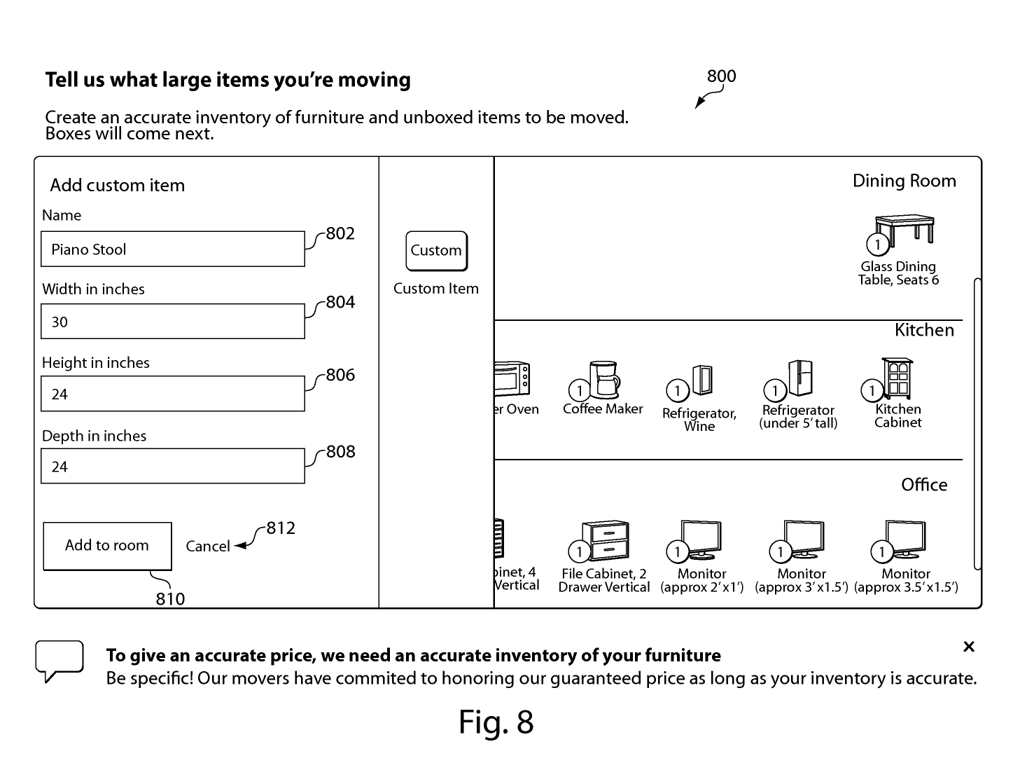

FIG. 8 depicts a representative screen interface 800 which enables a consumer to specify a size for a “custom” item (e.g., one which is not represented on a menu). On representative screen interface 800, a consumer may specify a name for a custom item via input facility 802, its width via input facility 804, its height via input facility 806, and its depth via input facility 808. The consumer may add the custom item to a particular “room” via input facility 810, or cancel the specification of the custom item via input facility 812.

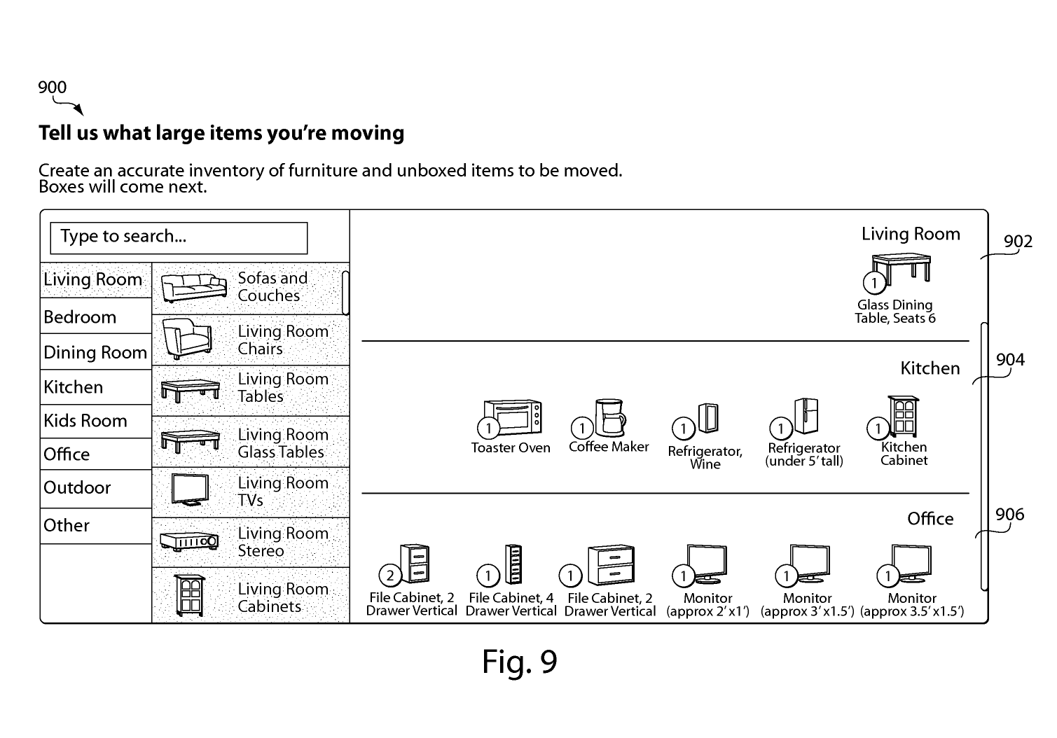

Representative screen interface 900, shown in FIG. 9, enables a consumer to review items specified as comprising an inventory. In the example shown, the consumer has specified an inventory which includes one table in the “Dining Room” (shown in area 902), a toaster oven, coffee maker, two wine refrigerators, a refrigerator and a kitchen cabinet in the “Kitchen” (shown in area 904), and two, 2-drawer vertical deep file cabinets, one four-drawer vertical deep file cabinet, one two drawer lateral file cabinet, one 3′×1.5′ monitor, one 2′×1′ monitor and one 3.5°×1.5′ monitor in the “Office” (shown in area 906). Any suitable quantity of items, and quantity of each item, may be added to an inventory, comprising any suitable number of rooms, as embodiments of the invention are not limited in this respect.

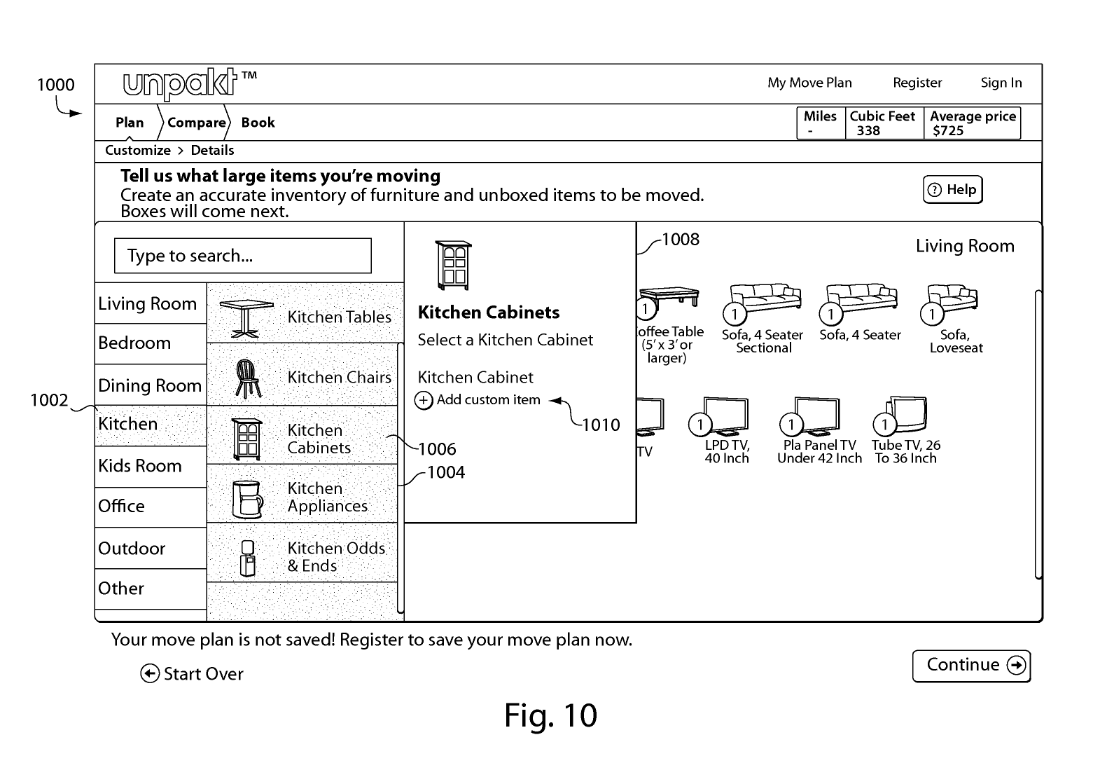

FIG. 10 depicts representative screen interface 1000, which enables a consumer to add an oversized item to an inventory. In the example shown, a consumer has indicated via facility 1002 that the oversized item resides in the “Kitchen” (causing menu 1004 to appear) and indicated via facility 1006 that the item is “Kitchen Cabinets” (causing display portion 1008 to appear). In the example shown, the consumer may specify a size for the kitchen cabinet by providing input via facility 1010, which may cause a set of input facilities similar to those described above in relation to FIG. 8 to be displayed.

In some embodiments of the invention, the system may guide a consumer through the process of creating an inventory by making available a sample inventory of items typically found in the type of residence from which the consumer is moving, and allowing the consumer to edit that sample inventory. For example, if a consumer indicates that she is moving from a studio apartment, then the system may suggest an inventory of items typically found in this type of residence. These “typical” items may be established in any suitable fashion, such as via observation of previous moves, heuristics, and/or using any other suitable information. In some embodiments, a sample inventory may vary based on geographic location. For example, a sample inventory for a one-bedroom apartment in New York City may be different than one for a one-bedroom apartment in a suburban location if it is known that the apartment in New York City typically stores fewer items. It should be appreciated, however, that a sample inventory may be defined based on information other than residence type. For example, information such as a consumer's age, gender, marital status and/or other information may be used to define a sample inventory of items.

It should be appreciated from the description above relating to FIGS. 5-10 that by enabling a consumer to specify the items to be transported during a move, and the size of one or more of the items, some embodiments of the invention may enable the total volume of items to be transported to be approximated. Given per-volume pricing information supplied by movers, the total approximate volume may enable a price for the move to be calculated, or the portion of that price which relates to the transportation of items (i.e., excluding the portion of the price that relates to other requested services).

It should also be appreciated that although the representative screen interfaces described above in relation to FIGS. 6-10 employ the metaphor of a residence and rooms therein to guide a consumer through the process of defining an inventory, not all embodiments of the invention are so limited. For example, other representative screen interfaces could use the metaphor of various rooms typically found in a business (e.g., offices, conference rooms, etc.) and/or another metaphor altogether (e.g., not based on “rooms”), or using no metaphor at all. A consumer may be guided through the inventory definition process in any suitable fashion.

It should further be appreciated that although the process described above in relation to FIGS. 5-10 involves a consumer constructing a move plan by specifying an inventory of items to be moved using a sequence of web pages presented via a browser, embodiments of the invention are not limited to this manner of implementation. For example, some embodiments of the invention may allow a consumer to submit a request for one or more movers to conduct an onsite visit at the location where the items to be transported are presently situated, so that the mover may establish the inventory of items to be moved. Other embodiments of the invention may enable a consumer and/or mover to construct an inventory of items to be transported by capturing video footage of those items (e.g., by a consumer carrying a video camera as she performs a “walk-through” of her apartment) and providing the video footage to one or more movers or other parties. Other embodiments of the invention may enable a consumer to define part of the overall inventory of items to be transported (e.g., via entry of information to one or more web pages and/or video capture), and one or more movers to establish the remainder of the overall inventory. An inventory of items to be transported may be established using any suitable tool(s) and/or technique(s), and by any suitable party or parties, as embodiments of the invention are not limited in this respect.

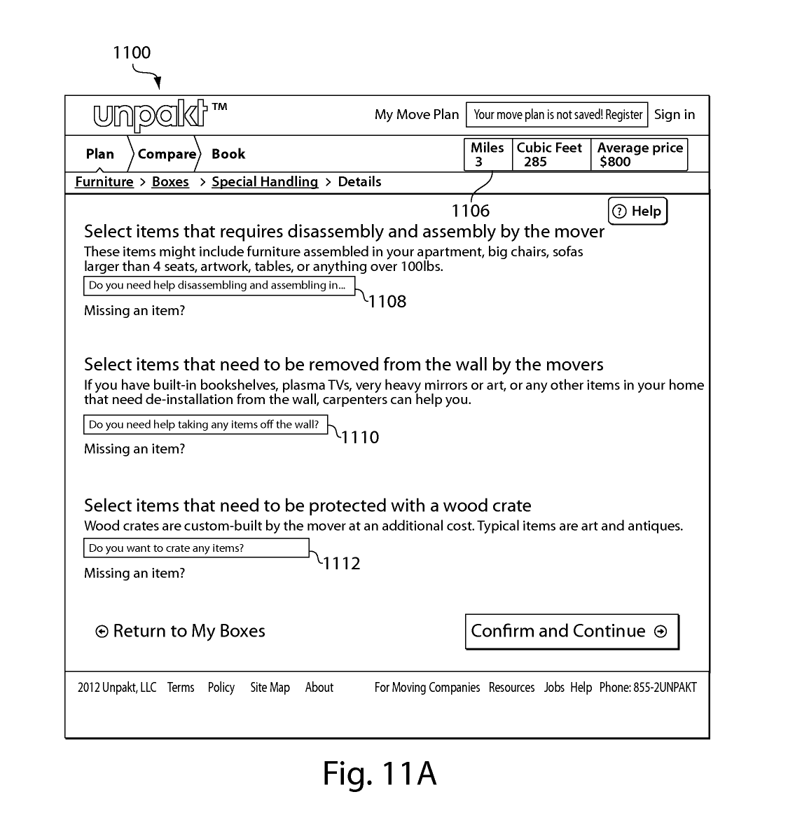

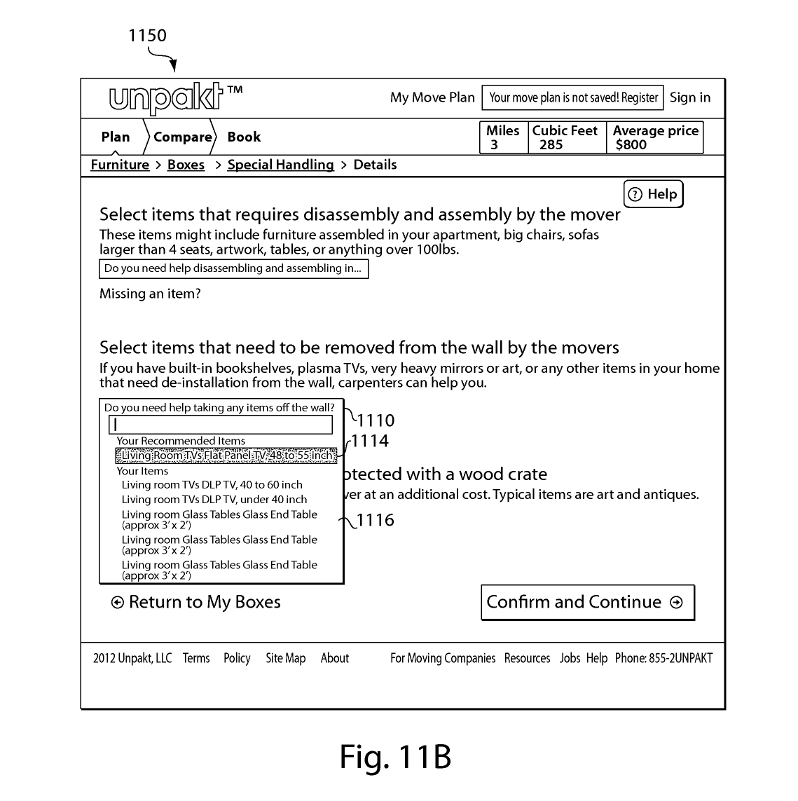

At the completion of act 510 (FIG. 5), representative process 500 proceeds to act 520, wherein, as a move plan is being defined, an estimated price for the move is shown to a consumer. This may be performed in any of numerous ways. One example, in which an estimated price is calculated based at least in part on a total volume of the items included in an inventory, is illustrated on representative screen interface 1100 (FIG. 11A). Specifically, representative screen interface 1100 includes display portion 1102, which shows an estimated price for a move which is based on a volume (shown in display portion 1104) of items included in an inventory defined using representative screen interfaces 600-1000 (described above in relation to FIGS. 6-10) and a distance over which those items are to be transported (shown in display portion 1106). In some embodiments, while a consumer defines a move plan and adds items to, or deletes items from, an inventory, the estimated price for the move may be updated in real time, so as to give the consumer a sense for how the inclusion or non-inclusion of certain items affects the estimated price.

An estimated price for a move may be calculated in any of numerous ways. In some embodiments, an estimated price may be calculated based on pricing information supplied by various movers. For example, in some embodiments, the estimated price shown in display portion 1102 may be an average of the price proposed by all movers which qualify and are available to handle the move. Of course, embodiments of the invention are not limited to such an implementation, as an estimated price may be calculated in any suitable fashion.

In constructing a move plan, a consumer may also request various ancillary services. In this respect, representative screen interface 1100 includes input facilities 1108, 1110, and 1112 which enable the consumer to request ancillary services which may affect the price quoted for the move. Specifically, facility 1108 allows a consumer to indicate that she would like disassembly and/or assembly of certain items, facility 1112 allows a consumer to select items to be protected with wood crating, and facility 1110 allows a consumer to request help with taking items off walls. Representative screen interface 1150 (FIG. 11B) depicts menu 1114 which is shown when a consumer indicates via facility 1110 that an item is to be removed from a wall. Menu 1112 includes items identified as part of an inventory created by the consumer, and includes an item 1114 (highlighted in FIG. 11B) which is recommended to be removed from a wall. An item may be recommended for any suitable reason, as embodiments of the invention are not limited in this respect. For example, items determined to be of a particular threshold volume, weight, and/or satisfying any other suitable criteria may be identified as recommended.

Some embodiments of the invention may prompt a consumer to supply information other than that which is illustrated in FIGS. 11A-11B to ensure a common understanding of services to be provided during a move. For example, in some embodiments, as a consumer defines an inventory of items, entry of certain information may lead to the consumer being prompted for other information, for services to be suggested, and/or for questions that otherwise may have been asked to be skipped. For example, if a consumer specifies a certain quantity of dishes to be moved, but does not specify a desire to purchase boxes (or does not indicate a desire to purchase a number of boxes sufficient to hold the quantity of dishes), the consumer may be asked whether he/she has enough boxes for the move, and/or may be prompted to buy more. In another example, if the consumer specifies that a plano is to be moved, he/she may be asked whether carpentry services are desired to take the plano apart prior to it being transported. Any suitable move-related services may be suggested, in any suitable manner, as embodiments of the invention are not limited in this respect.

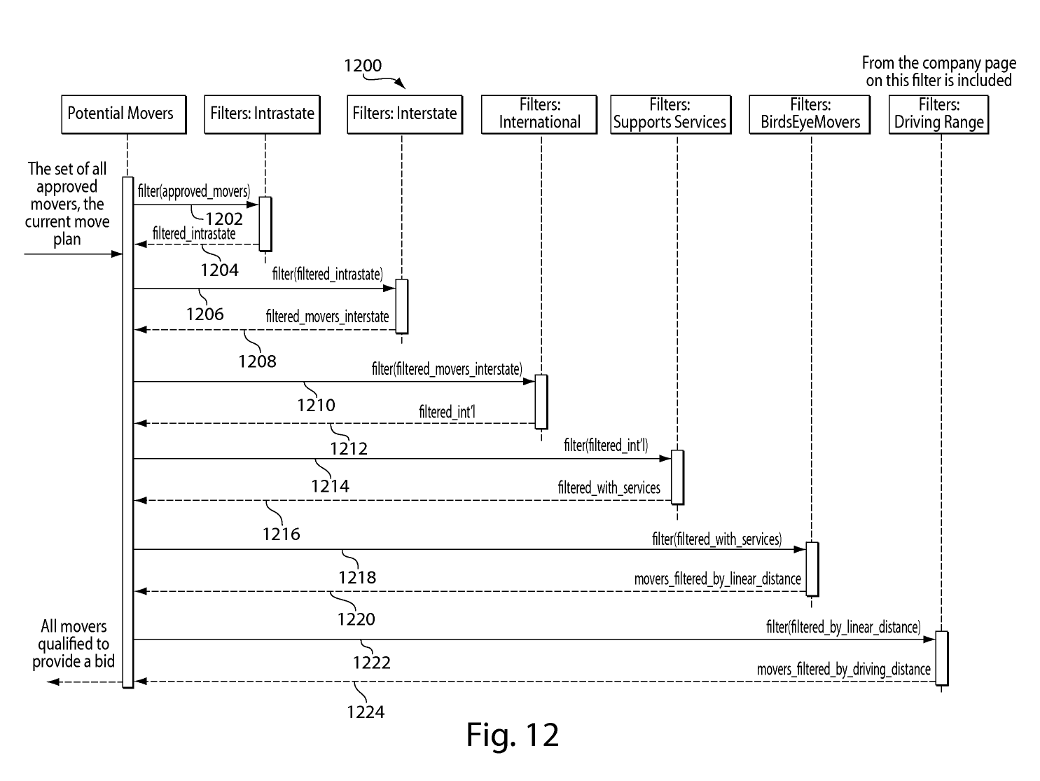

At the completion of act 520 (FIG. 5), representative process 500 proceeds to act 530, wherein candidate movers for a move are determined, and a price for each of those movers is calculated. Identifying candidate movers for a move may be performed in any of numerous ways. A representative technique 1200 is illustrated in FIG. 12, which involves the successive application of a collection of filters to a set of “approved” movers. In this respect, an approved mover may be one which satisfies any one or more criteria. For example, an “approved” mover may be one which has a history of abiding by binding quotes for moves, satisfies a minimum consumer rating threshold, and/or has any other suitable qualities.

In representative process 1200, application of the collection of filters includes a determination whether a mover supports intrastate moves (as indicated at 1202 and 1204), supports interstate moves (as indicated at 1206 and 1208), supports international moves (as indicated at 1210 and 1212), provides requested support services (as indicated at 1214 and 1216), supports moves within the geographical area in which the move is to take place (as indicated at 1218 and 1220) and supports moves of a distance requested by the consumer (as indicated at 1222 and 1224). In representative process 1200, the movers which satisfy the specified criteria are “qualified” to provide a bid for the move, and so pricing information supplied by these movers may be used to generate a quote for each for the move. It should be appreciated qualified movers may be identified using any suitable criteria, and not merely the collection of filters represented in FIG. 12. Examples of other criteria include whether or not a mover is licensed to perform moves in a state which a consumer moves to or from, and whether a mover is federally licensed. It should also be appreciated that a qualified mover need not be identified through the application of one or more filters. Any suitable technique, employing any suitable criteria to identify qualified movers, may be employed.

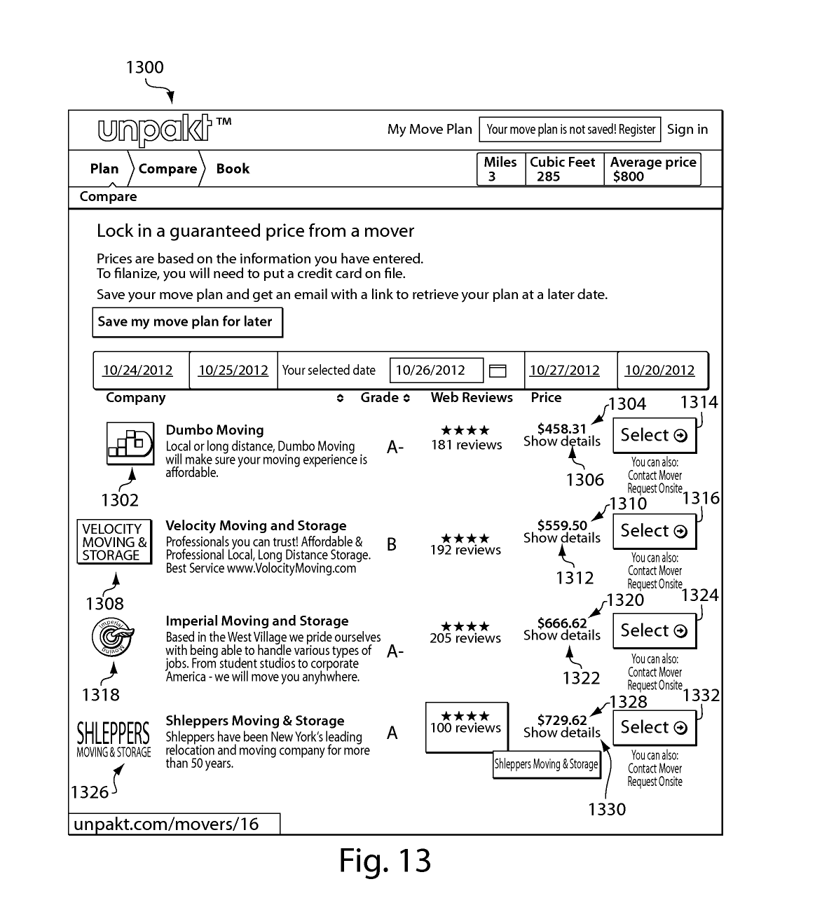

Representative process 500 then proceeds to act 540, wherein a facility is provided which enables a consumer to select a mover from the candidates identified in act 530. FIG. 13 depicts a representative screen interface 1300 which displays quotes from multiple movers for a move, and allows a consumer to select a mover. In the example shown in FIG. 13, area 1302 shows that “Dumbo Moving” would charge $458.31 for a move (as indicated at 1304), area 108 shows that “Velocity Moving and Storage” would charge $559.50 for the move (as indicated at 1308), area 1318 shows that “Imperial Moving and Storage” would charge $666.62 (as indicated at 1318), and area 1326 shows that “Shleppers Moving & Storage” would charge $729.62 (as indicated at 1326). A consumer may access detailed information relating to any quote by clicking on a “Show Details” link associated with it (e.g., the consumer could click on link 1306 to access details relating to the quote indicated at 1304). Detailed information may include, for example, terms and conditions relating to the quote, an indication of how the quoted price may change if services requested by the consumer were not included, an itemization of the portion of the price which relates to transporting items and the portion which relates to requested services, assumptions relating to the quote, and/or any other suitable information. In the example shown, a consumer may select a quote (and thus a mover) by clicking on it, and/or by providing any other suitable form of input.

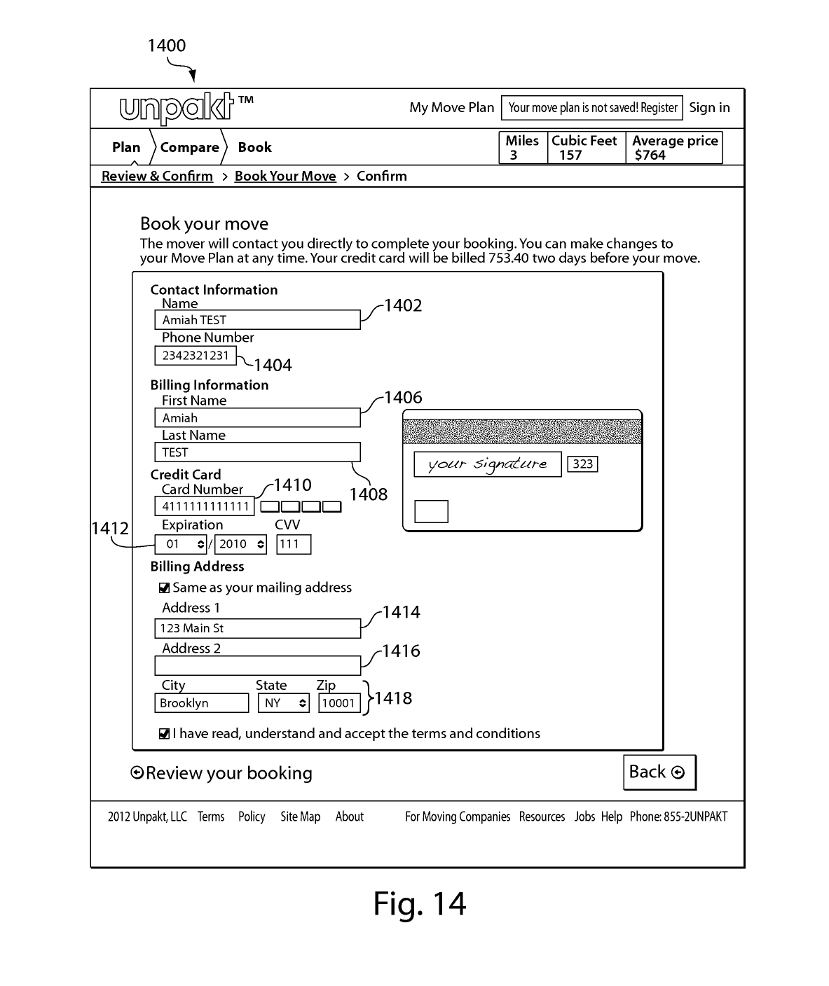

FIG. 14 depicts representative screen interface 1400, which allows a consumer to book a selected mover, thereby securing the mover's binding quote for the move. In the example shown, the consumer may book the move by providing contact and billing information. Specifically, the consumer may specify his/her name via input facility 1402, and phone number via input facility 1404. Billing information may include the consumer name supplied via input facilities 1406-1408, credit card number supplied via input facility 1410, expiration date supplied via input facility 1412, and billing address information supplied via input facilities 1414-1418. Although a consumer books a mover in the example shown by providing contact and billing information, any suitable technique may alternatively be used. If a mover is booked by the consumer providing information, any suitable information may be provided.

At the completion of act 540, a determination is made in act 550 whether the consumer wishes to make revisions to the move plan. If so, representative process 500 proceeds to act 560, wherein a facility of provided which allows revision of the plan. Such a facility may take any of numerous forms. In this respect, some embodiments of the invention recognize that a consumer may wish to revise a move plan after his/her computer has already been packed away in anticipation of the move. As such, some embodiments provide an application which may be accessed via any of numerous computing devices that the consumer may not have packed, such as a cellular telephone (e.g., a “smartphone”) or mobile computing device (e.g., personal digital assistant, tablet device, etc.) Such an application may, for example, enable a consumer to add items to or delete items from an earlier-specified inventory. For example, a consumer may specify that a couch, which had been included in an earlier-created inventory of items to be moved, has since been sold, so that it no longer needs to be moved by the mover. The consumer may log in, access his/her move plan, and adjust it.

Representative process 500 then proceeds to act 570, wherein an updated price for the move, based on the revised plan, is displayed. This may be performed in any of numerous ways. For example, an updated price for a move may be displayed on a cellular telephone or mobile computing device with which a consumer made revisions to a move plan. Any suitable tool(s) and/or technique(s) may be used.

At the completion of act 570, or if it is determined in the act 550 that no revisions are to be made to a move plan, representative process 500 completes.

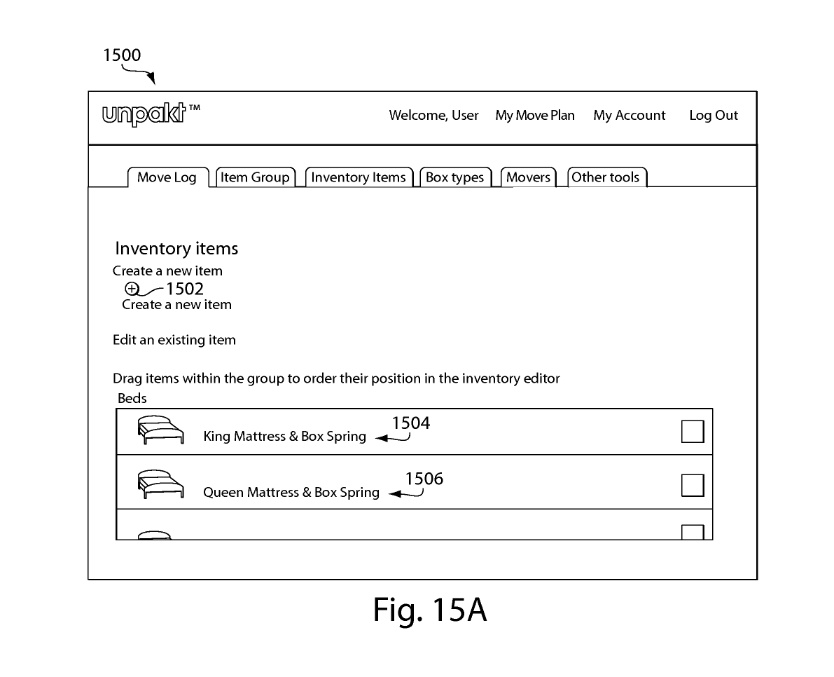

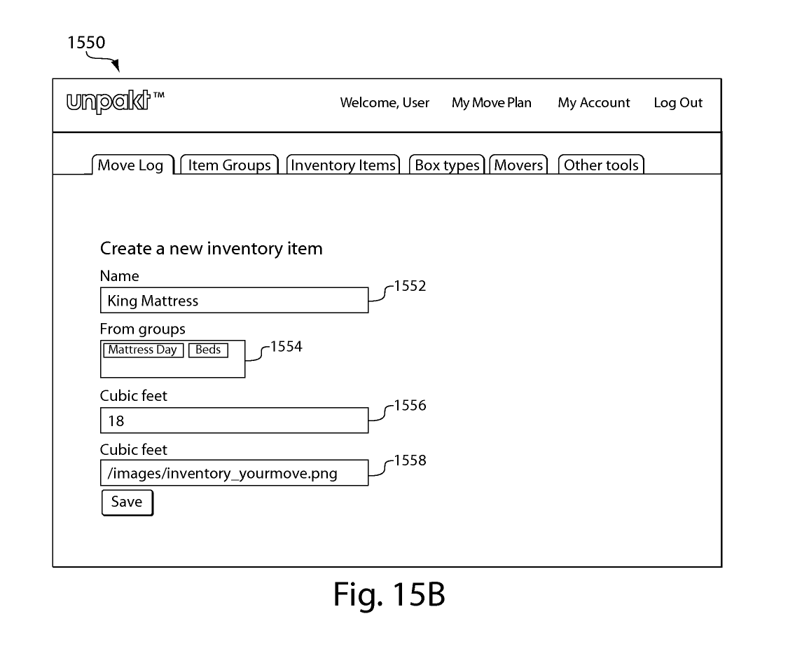

Some embodiments of the invention may provide a system which includes functionality not directly related to either a mover supplying pricing-related information, or a consumer defining a move plan. For example, FIGS. 15A-15B depict representative screen interfaces 1500 and 1550, which enable a user, such as a system administrator or customer service associate, to add a new type of item (e.g., a new piece of furniture, appliance, etc.) to the menu of items from which a consumer selects in constructing a move plan, or revise an existing item. Using representative screen interface 1500, the user may create a new item for inclusion in a list presented to consumers by providing input via facility 1502, or edit an existing item in the list by selecting the item (e.g., using either of input facilities 1504 or 1506). Representative screen interface 1550 may be shown when the user provides input via facility 1502. In the example shown, representative screen interface 1550 enables the user to supply a name for the new item (via input facility 1552), associate the new item with one or more item groups (via input facility 1554), specify a volume for the item (via input facility 1556), and/or provide a location for an icon for the item (via input facility 1558).

Some embodiments of the invention may provide support for consumers to arrange a move on a “back haul” between two locations. In this respect, if one consumer moves her belongings from New York City to San Francisco, the truck used to transport those belongings typically then returns to New York City, with the return leg of the trip being called the back haul. Often, moving trucks traveling along the back haul are empty. Some embodiments of the invention may enable one or more different consumers, who may be moving (in this example) from San Francisco (or some other city between San Francisco and New York City) to New York City (or some other city between San Francisco and New York City) to arrange for transportation of their belongings on the truck's back haul. In some embodiments of the invention, booking a move along a truck's back haul may allow the consumer to qualify for a discounted price for the move, since it may provide the mover with the opportunity to earn unexpected additional revenue. The availability of back haul moves may be presented to a consumer in any suitable fashion. For example, a back haul move opportunity may be displayed to a consumer as part of the quotes shown on representative interface 1300 (FIG. 13), such as with an indication that a discounted price may be available if the consumer is willing to be flexible on their move dates, to share a truck with one or more other consumers also interested in moving their belongings along the same back haul, etc.

It should be appreciated that although the examples given above relate to moves between two locations within the United States, embodiments of the invention are not so limited. For example, some embodiments of the invention may support the pricing, planning and/or coordination of moves from any origin location(s) to any destination location(s), worldwide.

Some embodiments of the invention may support consumer reviews of movers. For example, some embodiments may enable a consumer to rate a mover after a move has been completed. In this respect, some embodiments may accept reviews only from consumers which actually used a particular mover's services, thereby preventing false reviews of that mover (i.e., those submitted by individuals without firsthand experience with that mover), whether positive or negative. As such, consumer ratings may be more credible than ratings on conventional review sites.

Consumer reviews of movers may be employed for any suitable purpose. For example, reviews may contribute to a mover's “rating” on the system, which could, for example, be displayed to consumers with the mover's quotes for moves. A mover's rating could also, or alternatively, be used to identify movers qualified to perform a given move (e.g., a filter applied in a variation on representative process 1200 (FIG. 12) may identify movers satisfying a minimum rating threshold). Mover ratings may be used for any suitable purpose.

Of course, it should be appreciated that a mover's rating may account for information other than consumer reviews. For example, in some embodiments of the invention, a comparison of each mover's initial price quotes to prices ultimately charged to consumers may be made, and discrepancies may negatively affect the mover's rating. Any suitable information may be used in determining a mover's rating, as embodiments of the invention are not limited in this respect.

It should be appreciated that functionality provided by a system implemented in accordance with some embodiments of the invention may have uses other than those which are described above. For example, a variation on the system described above may be used as a “virtual back office” by a mover, enabling the mover to migrate to paperless operations. For example, a startup or nascent moving company without technical resources or a back-end planning or accounting capabilities could take advantage of the system's functionality to manage its operations, including the moves it performs for consumers.

In another example alternative use, embodiments of the invention may gather and/or aggregate data over time which is of interest to various parties. For example, data relating to consumers, moves, movers, buildings, etc., or derivations thereof, may be of interest to realtors, movers, and/or other parties. As an example, realtors may be interested in data such as the average number of moves per day from or to certain locations, the average distance moved, popular move destinations, the average price paid for a move between particular locations, etc. Movers may be interested, for example, in operational data such as the location at which fuel may be purchased least expensively between two locations, the prices charged by competitor movers to perform a move between particular locations, information on particular buildings (e.g., the availability of elevator facilities, number of stairways, etc.). Any suitable information may be collected and provided, in any suitable fashion, to any interested party.

It should also be appreciated that although the representative screen interfaces described above are of the type commonly displayed by a web browser executing on a personal computer, embodiments of the invention are not limited to this mode of implementation. For example, some embodiments of the invention may comprise one or more stand-alone applications, which may execute on any suitable device(s). For example, embodiments of the invention may be implemented via one or more “apps” suitable for execution on a mobile device, such as a smartphone, tablet and/or any other suitable mobile device(s). Any suitable mode of implementation may be employed.

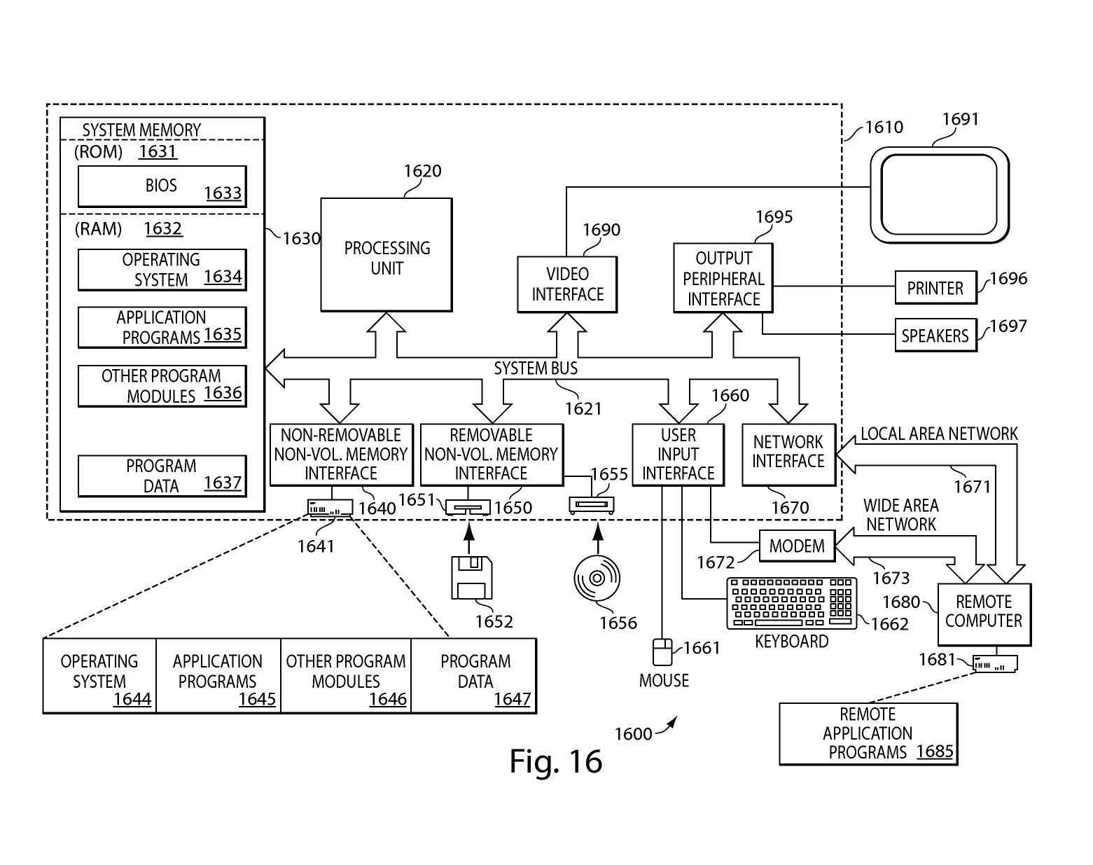

FIG. 16 illustrates one example of a suitable computing system environment 1600 which may be used to implement aspects of the invention. The computing system environment 1600 is only one example of a suitable computing environment, and is not intended to suggest any limitation as to the scope of use or functionality of the invention. Neither should the computing environment 1600 be interpreted as having any dependency or requirement relating to any one or combination of components illustrated in the exemplary operating environment 1600. In this respect, the invention is operational with numerous other general purpose or special purpose computing system environments or configurations. Examples of well-known computing systems, environments, and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 16 depicts a general purpose computing device in the form of a computer 1610. Components of computer 1610 may include, but are not limited to, a processing unit 1620, a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1610 typically includes a variety of computer readable media. Computer readable media can be any available media that can be accessed by computer 1610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 1610. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636, and program data 1637.

The computer 1610 may also include other removable/non-removable, volatile/nonvolatile computer storage media. By way of example only, FIG. 16 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through an non-removable memory interface such as interface 1640, and magnetic disk drive 1651 and optical disk drive 1655 are typically connected to the system bus 1621 by a removable memory interface, such as interface 1650.

The drives and their associated computer storage media discussed above and illustrated in FIG. 16, provide storage of computer readable instructions, data structures, program modules and other data for the computer 1610. In FIG. 16, for example, hard disk drive 1641 is illustrated as storing operating system 1644, application programs 1645, other program modules 1646, and program data 1647. Note that these components can either be the same as or different from operating system 1634, application programs 1635, other program modules 536, and program data 1637. Operating system 1644, application programs 1645, other program modules 1646, and program data 1647 are given different numbers here to illustrate that, at a minimum, they are different copies. A user may enter commands and information into the computer 1610 through input devices such as a keyboard 1662 and pointing device 1661, commonly referred to as a mouse, trackball or touch pad. Other input devices (not shown) may include a microphone, joystick, game pad, satellite dish, scanner, or the like. These and other input devices are often connected to the processing unit 1620 through a user input interface 560 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690. In addition to the monitor, computers may also include other peripheral output devices such as speakers 1697 and printer 1696, which may be connected through a output peripheral interface 1695.

The computer 1610 may operate in a networked environment using logical connections to one or more remote computers, such as a remote computer 1680. The remote computer 1680 may be a personal computer, a server, a router, a network PC, a peer device or other common network node, and typically includes many or all of the elements described above relative to the computer 1610, although only a memory storage device 1681 has been illustrated in FIG. 16. The logical connections depicted in FIG. 16 include a local area network (LAN) 1671 and a wide area network (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660, or other appropriate mechanism. In a networked environment, program modules depicted relative to the computer 1610, or portions thereof, may be stored in the remote memory storage device. By way of example, and not limitation, FIG. 16 illustrates remote application programs 1685 as residing on memory device 1681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer system for making available information indicating a quality of service provided by each of a plurality of movers, the computer system comprising:
at least one computer processor programmed to:
(A) determine whether a consumer engaged one of a plurality of movers to perform a move;
(B) if it is determined that the consumer engaged one of the plurality of movers to perform a move, enabling the consumer to submit a review of the one mover;
(C) if it is determined that the consumer did not engage one of the plurality of movers to perform a move, preventing the consumer from submitting a review of the one mover.

2. The computer system of claim 1, wherein (B) comprises, if it is determined that the consumer engaged one of the plurality of movers to perform a move, enabling the consumer to submit a rating of the one mover's performance during the move.

3. The computer system of claim 2, wherein the at least one processor is programmed to:
(D) employ the rating of the mover's performance during the move, submitted by the consumer in (B), in determining whether the one mover is qualified to perform a move for a second consumer.

4. The computer system of claim 2, wherein the at least one processor is programmed to:
(D) employ the rating of the mover's performance during the move, submitted by the consumer in (B), in determining an overall rating for the one mover.

5. The computer system of claim 4 wherein (D) comprises employing a comparison between price quotes initially provided by the one mover for moves and prices ultimately charged by the one mover for the moves in determining the overall rating for the one mover.
